(19) United States
(12) Patent Application Publication
(10) Pub. No.: US 2026/0093352 A1
(43) Pub. Date: Apr. 2, 2026

(54) Gating Surface Touch Sensor based on Hand and Object Proximity

(71) Applicant: Apple Inc., Cupertino, CA (US)

(72) Inventors: Warren J Seto, Sunnyvale, CA (US); Nurul Islam, Mountain View, CA (US); Thayne M. Miller, Escondido, CA (US)

(21) Appl. No.: 19/340,547

(22) Filed: Sep. 25, 2025

Related U.S. Application Data
(60) Provisional application No. 63/700,524, filed on Sep. 27, 2024.

(51) Int. Cl. G06F 3/041; G06F 3/01; G06F 3/042

(52) U.S. Cl. CPC G06F 3/0416; G06F 3/017; G06F 3/0425

(57) ABSTRACT

Detecting a touch includes determining, based on first sensor data of a first type, a hand location of a hand. In response to determining that the hand location satisfies a proximity threshold to a physical surface, a monitoring process of a surface of the hand, including capturing second sensor data of a second type different than the first sensor data, and determine a touch status based on second sensor data. The first sensor data is camera data and the second sensor data is vibration data. The camera sensor and the vibration sensor are included in a wearable device. For multifinger gestures, the second sensor data is captured for multiple fingers. The touch status is determined for each finger based on the second sensor data.

### BACKGROUND

This disclosure relates generally to the field of touch detection, and more specifically to a technique for gating surface touch sensors based on proximity data.

Today's electronic devices provide users with many ways to interact with electronic devices. For example, users may interact with electronic devices using virtual or physical keyboards, mice, trackballs, joysticks, touch screens, and the like. Current technology allows users to interact with electronic devices by using touch detection to determine whether a user has made contact with a physical surface, such as by tapping the surface.

What is needed is an improved technique for detecting surface touch.

### BRIEF DESCRIPTION OF THE DRAWINGS

FIGS. 1A-1B show simplified system diagrams of a system setup for surface touch detection, according to one or more embodiments.

FIG. 2 shows, in flowchart form, a technique for gating surface touch detection, according to one or more embodiments.

FIG. 3 shows, in flowchart form, an example technique for determining a proximity between a hand and a surface, in accordance with one or more embodiments.

FIG. 4 shows an example diagram for determining a gap distance between a fingertip and a surface, according to one or more embodiments.

FIG. 5 shows, in flowchart form, an example technique for detecting a make event, according to one or more embodiments.

FIG. 6 shows, in flowchart form, an example technique for detecting a break event, according to one or more embodiments.

FIGS. 7A-7D shows example diagrams of a technique for using surface touch detection, according t o one or more embodiments.

FIG. 8 shows, in flowchart form, an example technique for detecting multifinger touch, in accordance with one or more embodiments.

FIG. 9 shows an example diagram of a technique for detecting multifinger touch, in accordance with one or more embodiments.

FIG. 10 shows, a simplified network diagram with components for detecting surface touch, according to one or more embodiments.

FIG. 11 shows, in block diagram form, a simplified multifunctional device according to one or more embodiments.

### DETAILED DESCRIPTION

This disclosure is directed to systems, methods, and computer readable media for detecting touch on a surface in a physical environment. In particular, this disclosure is directed to a technique for gating touch detection monitoring based on a proximity of a hand to a surface.

One way that surface touch is detected is by using vibration sensors. For example, vibration sensors may be used to probe the physical surface to determine if the physical surface has been tapped by the finger. However, one of the primary challenges of the traditional use of vibration sensors is power consumption. Traditional vibration sensors are often continuously active, constantly monitoring for touch events. This continuous operation can drain the device's battery quickly, making it less efficient for long-term use.

Another challenge with traditional vibration sensors is that they can have limited accuracy, as they can sometimes detect vibrations from environmental factors that are then registered as false touches. On the other hand, if the vibration sensor is not calibrated with a high enough sensitivity, the vibration sensor may miss touch events.

In general, techniques provided herein are directed to using a first set of sensor data to monitor a proximity of a hand to a surface.

When the proximity satisfies a threshold value, then a secondary monitoring process is initiated using different sensor data in order to determine a touch status of a hand. The first sensor data and second sensor data may be collected from a same or different sensor or sensor type. In some embodiments, the first sensor data includes camera data, whereas the second sensor data includes vibration data.

According to some embodiments, a proximity between the hand and the surface is determined using image data captured by a camera. The location of the hand and the location of the surface may be determined using the same or different techniques. For example, a location of the hand may be obtained by a hand tracking pipeline which is configured to track characteristics of the hand, such as joint locations, pose, and the like. A location of the surface may be determined based on the image data captured by the camera. The proximity may be determined based on a difference between the locations of the hand and the surface.

When proximity satisfies a threshold value, a secondary monitoring process is initiated. The secondary monitoring process may use different sensor data, either from a same or different sensor than the sensor used to monitor proximity. The secondary monitoring process may be used to track characteristics of a surface of the hand to detect touch, without probing the surface directly. For example, a vibration sensor may be used to detect a touch event. In some embodiments, initiating the secondary monitoring process may include initiating probing of a surface of the hand for vibration data.

Determining the touch status in the second monitoring process may use a combination of the first and second sensor data to detect a touch. For example, the hand location data can be used to track velocity of the and/or particular joints or locations of the hand. Characteristics of the hand velocity may be considered along with a gap distance between a fingertip and the surface to determine a touch status. The touch status may include a particular phase of a touch event, such as no touch, a make event at which point the finger touches down on a surface, a touch when the fingertip is in contact with the surface, a break event at which point the fingertip separates from the surface. In some embodiments, input actions may be configured to be triggered in accordance with different touch statuses, such as a make event or a break event.

According to some embodiments, by selectively powering up the second monitoring technique, power and/or compute can be preserved. For example, a vibration sensor or other sensor may only track vibrations when the hand is within a threshold distance of a surface, and thereby more likely to perform a touch event. Further, by using vibration data for touch detection, less image processing on the camera data is necessary than if a fully vision-based touch detection technique were used.

In the following description, for purposes of explanation, numerous specific details are set forth in order to provide a thorough understanding of the disclosed concepts. As part of this description, some of this disclosure's drawings represent structures and devices in block diagram form in order to avoid obscuring the novel aspects of the disclosed embodiments. In this context, it should be understood that references to numbered drawing elements without associated identifiers (e.g., 100) refer to all instances of the drawing element with identifiers (e.g., 100a and 100b). Further, as part of this description, some of this disclosure's drawings may be provided in the form of a flow diagram. The boxes in any particular flow diagram may be presented in a particular order. However, it should be understood that the particular flow of any flow diagram is used only to exemplify one embodiment. In other embodiments, any of the various components depicted in the flow diagram may be deleted, or the components may be performed in a different order, or even concurrently. In addition, other embodiments may include additional steps not depicted as part of the flow diagram. The language used in this disclosure has been principally selected for readability and instructional purposes, and may not have been selected to delineate or circumscribe the disclosed subject matter. Reference in this disclosure to “one embodiment” or to “an embodiment” means that a particular feature, structure, or characteristic described in connection with the embodiment is included in at least one embodiment, and multiple references to “one embodiment” or to “an embodiment” should not be understood as necessarily all referring to the same embodiment or to different embodiments.

It should be appreciated that in the development of any actual implementation (as in any development project), numerous decisions must be made to achieve the developers'specific goals (e.g., compliance with system and business-related constraints), and that these goals will vary from one implementation to another. It will also be appreciated that such development efforts might be complex and time consuming, but would nevertheless be a routine undertaking for those of ordinary skill in the art of image capture having the benefit of this disclosure.

For purposes of this disclosure, the term “camera system” refers to one or more lens assemblies along with the one or more sensor elements and other circuitry utilized to capture an image. For purposes of this disclosure, the “camera” may include more than one camera system, such as a stereo camera system, multi-camera system, or a camera system capable of sensing the depth of the captured scene.

For purposes of this disclosure, the term “vibration sensor” refers to a non-contact sensor configured to measure characteristics of vibration of a probed surface. That is, the vibration sensor detects vibration on a surface without making contact with the surface. Example vibration sensors include laser displacement sensors, solid state proximity sensors, or the like.

A physical environment refers to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an extended reality (XR) environment refers to a wholly or partially simulated environment that people sense and/or interact with via an electronic device. For example, the XR environment may include augmented reality (AR) content, mixed reality (MR) content, virtual reality (VR) content, and/or the like. With an XR system, a subset of a person's physical motions, or representations thereof, are tracked, and, in response, one or more characteristics of one or more virtual objects simulated in the XR environment are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands).

There are many different types of electronic systems that enable a person to sense and/or interact with various XR environments.

Examples include head mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mountable system may have one or more speaker(s) and an integrated opaque display. Alternatively, a head mountable system may be configured to accept an external opaque display (e.g., a smartphone). The head mountable system may incorporate one or more imaging sensors to capture images or video of the physical environment, and/or one or more microphones to capture audio of the physical environment. Rather than an opaque display, a head mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

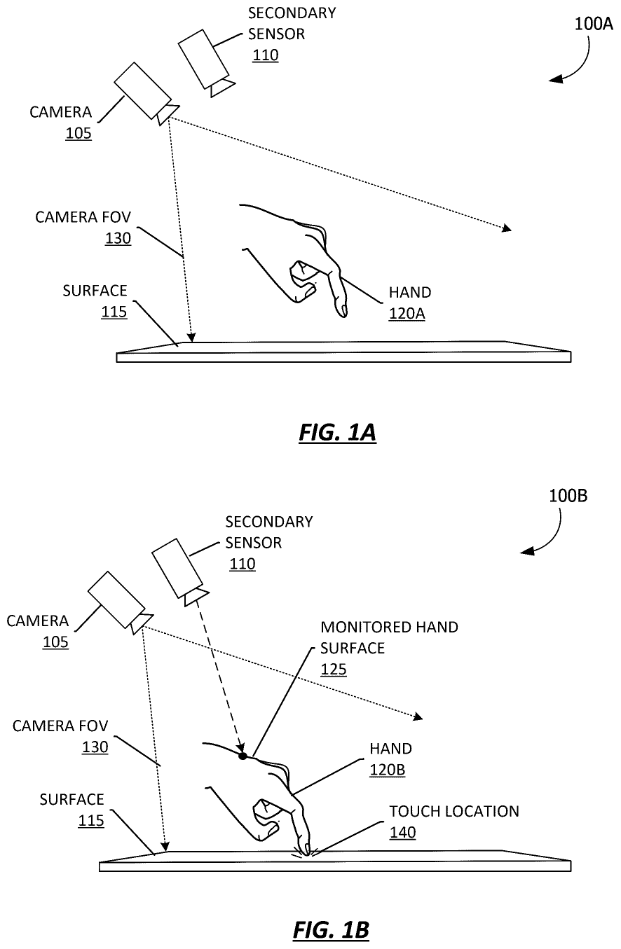

Turning to FIG. 1A, a system diagram is presented in which touch may be detected. The view 100A shown in FIG. 1A depicts the system setup prior to a touch event being performed. The system setup 100A includes a camera 105 capturing image data of a hand 120A as it is moving toward the surface 115. Although a camera is shown, it should be understood that an alternate sensor may be used in addition to or in place of camera 105 to capture sensor data of the hand 120A.

In addition to the camera 105, the system setup also include a secondary sensor 110. The secondary sensor may be the same or different than camera 105. Further, in some embodiments, a single sensor may be used in two different modes. In some embodiments, the secondary sensor 110 may be configured to capture vibration data of a surface. To that end, the secondary sensor may be a contactless vibrometer.

According to some embodiments, the secondary sensor 110 may capture sensor data of the hand 120A when sensor data capture is initialized based on a triggering state driven by sensor data captured by the camera 105 or other primary sensor. For example, the secondary sensor 110 may not capture sensor data of the hand 120A until the hand 120A is determined to be within a threshold distance of surface 115. Alternatively, the secondary sensor 110 may be capturing sensor data, but the sensor data may not be used to touch detection until the hand 120A is within a threshold distance of surface 115. Said another way, surface touch may be gated based on a proximity of the hand and surface.

According to some embodiments, the camera 105 and the secondary sensor 110 may be part of separate devices communicably coupled to each other, or may be part of a single device. In some embodiments, the camera 105 and the secondary sensor 110 may be encased in a wearable device, such as a head mounted device, and the camera 105 and the secondary sensor 110 may be outward-facing sensors.

Turning to FIG. 1B, the hand 120B may be determined to be within a threshold distance of the surface in view 100B. The distance between the hand and the surface may be determined in a number of ways. For example, a device may capture hand tracking data using camera 105, secondary sensor 110, one or more additional sensors, or some combination thereof. The hand tracking data may be used to determine location information for all or part of a hand, such as joint locations for a hand, from which a hand position and location can be derived. For purposes of touch detection, a location of the hand may be determined based on a touching portion of the hand, such as a fingertip or a finger pad.

According to some embodiments, the location information for the hand may be compared to a location of the surface 115. The surface 115 may be a flat surface, or may be a curved or irregular surface.

The location of the surface may be determined in a number of ways.

For example, a scan may be performed of the physical environment, in which surface 115 may be detected. In some embodiments, a wearable device which is configured to capture depth of a scene from the point of view of the device. The depth or location of the surface can then be compared with the location information for the hand 120B. In addition, characteristics of the physical environment can be determined using stereophotogrammetry.

A proximity of the hand may be determined based on the distance between the hand 120B and the surface 115. If the proximity satisfies a predefined threshold, then secondary sensor 110 can be activated. The secondary sensor 110 may be configured to capture sensor data of a surface of the hand 120B, from which characteristics of the surface of the hand 125 can be determined. In some embodiments, once the image data captured from the camera 105 indicates that the hand 120B is within a predefined proximity to the surface 115, then the secondary sensor 110 may be configured to probe a particular location or locations on the surface of the hand 120B, such as one or more points on the back of the hand 120B, shown as monitored surface of the hand 125. When the secondary sensor data indicates that a touch has occurred (for example, when vibration data indicates a collision between the hand and an object has occurred), a determination of a touch location 140 may be made based on the image data from the camera 105 and, optionally, the additional sensor data from secondary sensor 110.

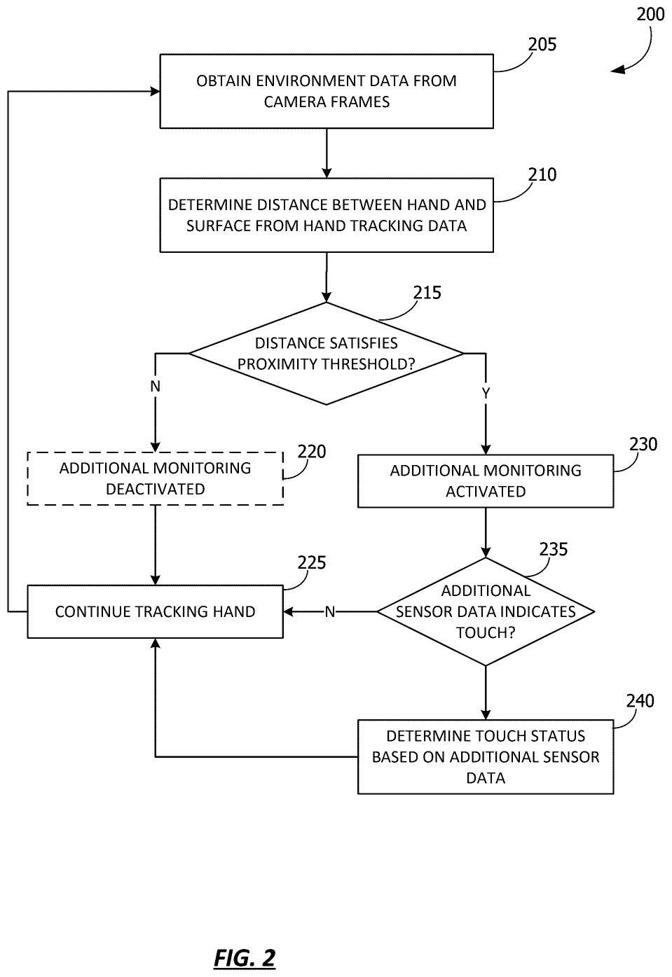

Turning to FIG. 2, a flowchart is presented illustrating an example technique for gating touch detection, in accordance with one or more embodiments. For purposes of explanation, the following steps will be described in the context of FIGS. 1A-1B. However, it should be understood that the various actions may be taken by alternate components. In addition, the various actions may be performed in a different order. Further, some actions may be performed simultaneously, and some may not be required, or others may be added.

The flowchart 200 begins at block 205, where environment data is obtained from camera frames. Environment data may include, for example, hand tracking data, scene understanding data, or the like.

Hand tracking data may include location information for a hand, or a portion of a hand. The hand tracking data may be based on depth information for the hand as depicted in the camera frames, such as frames captured by camera 105, or another camera having a field of view in which the hand is visible. In some embodiments, hand tracking data may be obtained from a more complex pipeline, in which characteristics of the hand are determined based on the camera data. For example, location information for one or more joints may be estimated from the image data. From the joint location information, a hand pose and location may be determined. For purposes of gating touch detection processes, the location of a hand may be determined with respect to a representative point of the hand, such as a central point of the hand, the fingertip expected to perform a touch of event, or the like. Scene understanding data may be used to identify surfaces, contours, and other characteristics in the environment.

The flowchart 200 proceeds to block 210, where proximity is determined based on a distance between the hand and a surface. The proximity may be determined based on the hand tracking data. In some embodiments, the distance may be determined between any surface detected in an environment, a subset of surfaces and the environment, or a particular surface in the environment. For example, some surfaces in the environment may be registered as interactive surfaces, or otherwise activated to be associated with user input actions initiated based on touch. Thus, proximity may be determined with respect to these surfaces, whereas proximity to other surfaces in the environment may be ignored.

At block 215, a determination is made as to whether the distance satisfies a proximity threshold. The proximity threshold may be a distance between the hand and the surface at which secondary information should be monitored in order to determine whether a touch event has occurred. The proximity threshold may be a predefined distance from a particular portion of the hand to the surface. The proximity distance may be specific to a particular surface or surfaces. That is, a predefined proximity threshold may differ depending upon the surface for which proximity is determined. Further, other parameters may be used to determine whether a proximity threshold is satisfied. For example, a velocity of the hand movement may affect the proximity threshold used for the determination. As another example, the particular context of the user and/or environment may be used to adjust the proximity threshold.

If a determination is made that the distance satisfies a proximity threshold, then the flowchart proceeds to block 230, and touch detection monitoring is activated. Touch detection monitoring may include an additional monitoring process, and may include capturing additional sensor data and determining whether the additional sensor data is indicative of a touch event. In some embodiments, the additional sensor data may be analyzed for specific touch-related signals, such as vibrations or pressure changes. For example, one or more points on the back of the hand may be probed by a contactless vibration sensor to collect sensor data corresponding to characteristics of motion on the surface of the hand without the sensor making contact with the hand.

The flowchart 200 proceeds to block 235, where a determination is made as to whether additional sensor data indicates a touch even has occurred. Determining a touch may involve detecting a vibration signal indicative of a collision event between the hand and a surface.

In some embodiments, the sensor data for the detected event may be analyzed in conjunction with other data, such as image data captured by a camera, to confirm the touch event actually occurred. For example, a gap distance between the finger and the surface may be estimated to determine whether to confirm the touch event. Notably, the gap distance used to confirm a touch may differ from the proximity between the hand and surface used to gate the touch detection process. In some embodiments, the determination may be performed on a per-frame basis, or based on selective frames or subsets of frames.

If the additional sensor data indicates that a touch has occurred, the flowchart proceeds to block 240. At block 240, a touch status is determined. The touch status determination may include determining whether a touch has occurred, is currently occurring, is likely to occur, or the like. Further, in some embodiments, determining the touch status may include detecting a phase of a touch event, such as a touch down, a touch release, and the like.

The flowchart proceeds to block 225, where hand tracking continues. The flowchart 200 also proceeds to block 225 from decision block 235 if a determination is made that the additional sensor data does not indicate a touch. In particular, the location of the hand is tracked to determine approximate distance from a surface. The flowchart then returns to block 205, where hand tracking data continues to be collected and/or determined.

Returning to block 215, if a determination is made that a distance between a hand and a surface does not satisfy proximity threshold, then the flowchart optionally proceeds to block 220. At block 220, additional monitoring for touch detection is deactivated.

That is, if the secondary sensor has been activated for collecting sensor data used for touch detection, and the determination at decision block 215 indicates that the hand is no longer within a threshold proximate distance of the surface, then the touch detection process may terminate. As such, the secondary sensor data may no longer be collected. The flowchart then proceeds to block 225, where the hand is continued to be tracked using the camera frames, or the primary sensor data used to determine proximate distance to a surface.

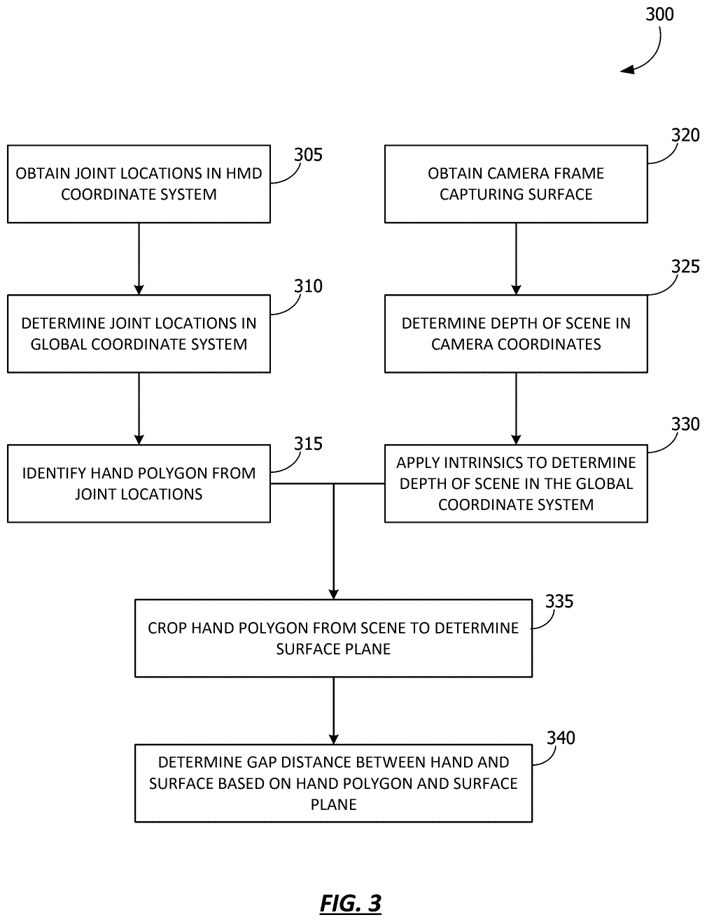

Turning to FIG. 3, a flowchart is presented illustrating an example technique for determining a gap distance between a hand and a surface for touch detection, in accordance with one or more embodiments. In particular, FIG. 3 shows an example technique for detecting touch using a gap distance between the hand and the surface. For purposes of explanation, the following steps will be described in the context of particular components. However, it should be understood that the various actions may be taken by alternate components. In addition, the various actions may be performed in a different order. Further, some actions may be performed simultaneously, and some may not be required, or others may be added.

The flowchart 300 begins at block 305, where joint locations are obtained in a coordinate system of an electronic device capturing the joint locations, such as a head mounted device (“HMD”) or other wearable or mobile device. In some embodiments, the electronic device may run a hand tracking pipeline, which is configured to process sensor data to detect and track the positions of various joints of the hand, such as the wrist, knuckles, and fingertips, as well as determine a hand pose, orientation, or the like. In some embodiments, the joint locations may correspond to real-world joints in the hand.

Alternatively, some or all of the tracked joint locations may represent tracked points of the hand which may or may not correlate to a user's anatomical joints. The hand tracking data is then used to generate joint locations in a first coordinate system, such as a coordinate system corresponding to the HMD or device performing hand tracking. As another example, the joint location data may be determined in a coordinate system for the user.

The flowchart proceeds to block 310, where the joint locations are determined in a global coordinate system. The global coordinate system may be a fixed coordinate system that is independent of the HMD device and that represents the real-world environment. The joint locations in the HMD coordinate system (or first coordinate system from step 305) may be transformed into the global coordinate system by taking into account the position of the HMD in the real-world environment, such as an HMD position and/or orientation. The HMD position and/or orientation may be determined using one of more localization technique, such as using location and/or orientation sensor data captured by sensors on the HMD, image-based localization based on camera data captured by the HMD, such as simultaneous localization and mapping (“SLAM”), or the like, or some combination thereof.

At block 315, a hand polygon is determined from the point locations. According to one or more embodiments, the hand polygon is a two-dimensional representation of the hand geometry that is projected into the field of view of the camera. The hand polygon can be formed by determining a plane in space corresponding to the hand, and may indicate the boundaries of the hand in a coordinate system that can be compared to image data capturing the hand.

Returning to the beginning of flowchart 300, at block 320, one or more camera frames are obtained which capture the surface. In some embodiments, the camera may be configured to capture RGB images. Additionally, or alternatively, the camera may be configured to capture depth information. The surface is the object or area that the user may intend to touch or interact with using the hand. In some embodiments, the surface is a registered or activated surface, such that the user interaction with the surface triggers a computational process. The surface can be a flat surface such as a table, a wall, a screen, or any other flat or curved surface. In some embodiments, irregular and/or soft surfaces may also be activated or registered for user interaction.

The flowchart 300 proceeds to block 325, where a depth of the scene in determined in a camera coordinate system. The camera coordinate system is a local coordinate system that is defined by the position and orientation of the camera. The depth of the scene may indicate the distance from the camera capturing the scene to each point or pixel in the scene, or a subset thereof. The depth of the scene can be obtained from the camera frame using various methods, such as stereo matching, structured light, time-of-flight, comparison to a 3D model of the environment or portion of the environment, or the like.

At block 330, camera intrinsics for the camera capturing the surface are applied to determine the depth of the scene in the global coordinate system. The camera intrinsics are parameters that describe the internal characteristics of the camera, such as the focal length, the optical center, and camera coefficients. The camera intrinsics can be used to map the points or pixels in the camera frame to their corresponding locations in the global coordinate system. The depth of the scene in the global coordinate system can be used to generate a scene geometry that defines the shape and orientation of the scene in the three-dimensional space.

Once the joint locations and hand polygon are determined in the global coordinate system at block 310 and 315, and the scene is determined in the global coordinate system, the flowchart 300 proceeds to block 335. At block 335, the hand polygon is cropped from the camera frame to determine the surface plane. The remaining portion of the image frame, around the hand geometry, is likely to be the surface the user intends to touch, or is most likely to touch. Accordingly, the depth of this region of the frame can be inspected from the depth of scene to identify a depth of the surface.

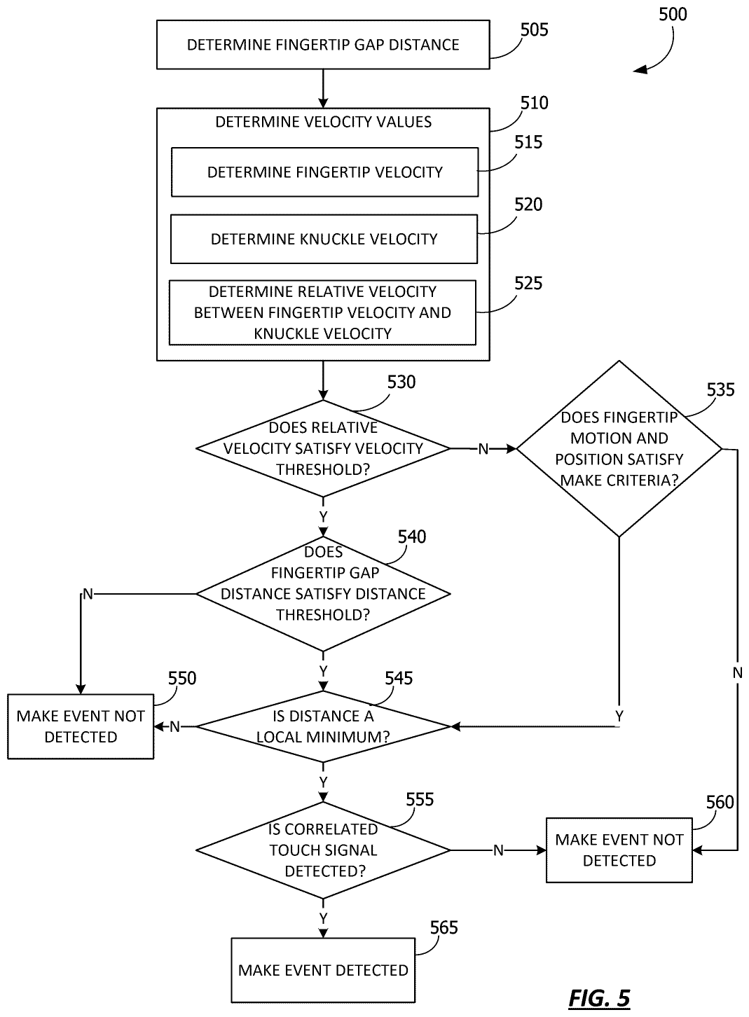

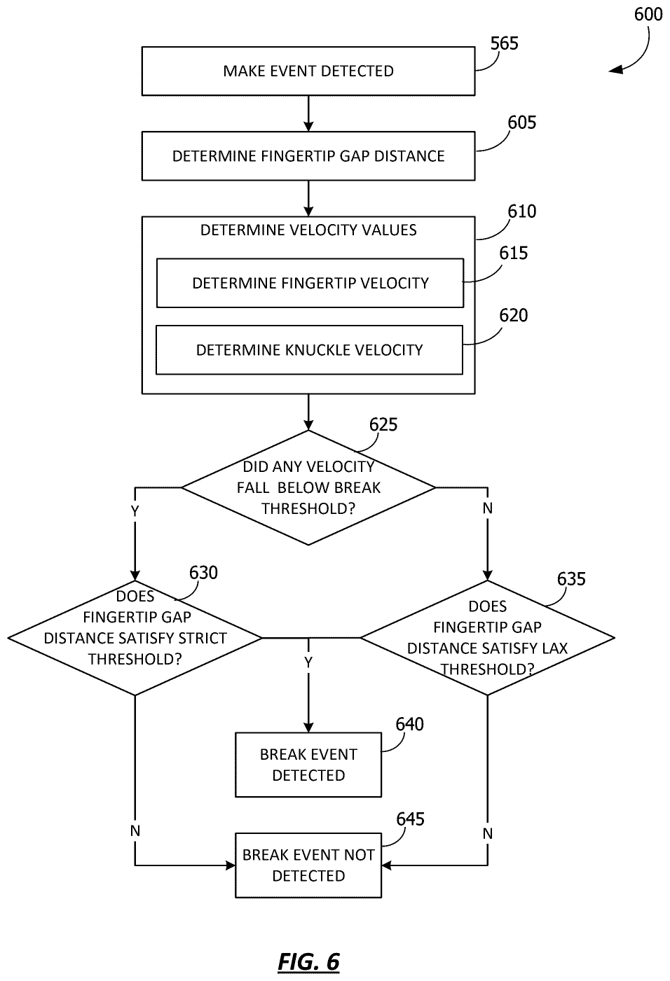

The flowchart 300 concludes at bock 340, where a gap distance is determined between the hand and the surface. According to some embodiments, the gap distance between the hand and the surface is determined based on a depth of the surface and a depth of the hand in a common coordinate system. The gap distance is the distance between the depth of the surface and the depth of the hand. The gap distance can be used to determine whether the hand is touching or hovering over the surface. For example, if the gap distance is below a threshold value, a touch even may be determined to have occurred or may be determined to be occurring, or may be used in conjunction with additional parameters to determine whether a touch has occurred. As will be described in greater detail below with respect to FIGS. 5-6, detecting the touch may additionally include determining a phase of the touch, such as a make event or a break event.

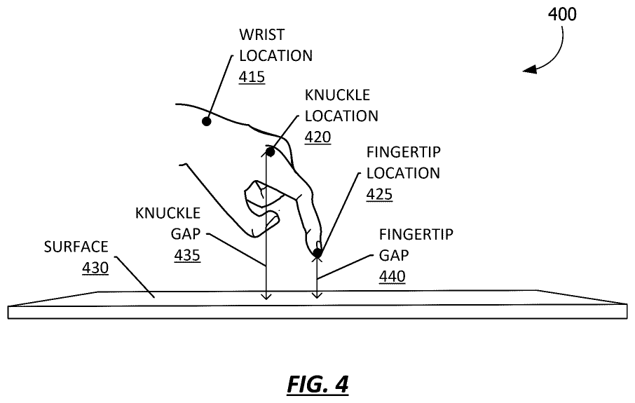

In some embodiments, characteristics of a touch, such as whether a touch has occurred or different phases of a touch event, can be determined based on different factors. FIG. 4 shows an example diagram for determining a gap distance between a fingertip and a surface, according to one or more embodiments. In particular, FIG. 4 shows an example diagram of a hand 450 near a surface 430, along with various example portions of the hand which may be tracked for determining a gap distance for touch detection. As will be described in greater detail below, by tracking different portions of the hand, and the relative velocities thereof, a determination may be made as to whether the hand is performing a make event, in which the hand 450 initially makes contact with the surface 430, or a break event, in which the hand 450 is released from the surface 430. The different components include a wrist location 415, a knuckle location 420, and a fingertip location 425. For purposes of determining the gap distance, the fingertip gap 440 may be determined, which indicates a distance between the fingertip location 425 and the surface 430. For determining make or break events, a knuckle gap 435 may additionally be considered. The knuckle gap 435 is the distance between a knuckle location 420 and the surface 430.

Turning to FIG. 5, an example technique for detecting a make event is presented in flowchart form, according to one or more embodiments. For purposes of explanation, the following steps will be described in the context of FIG. 4. However, it should be understood that the various actions may be taken by alternate components. In addition, the various actions may be performed in a different order. Further, some actions may be performed simultaneously, and some may not be required, or others may be added.

The flowchart begins at block 505, where the process determines a fingertip gap distance 440 based on first sensor data of a first type. For example, the first sensor data may include camera data that captures the hand and the physical surface. As described above, a hand tracking technique may process the camera data to estimate joint location information, and a depth of scene may be determined from the camera frame. The distance between a fingertip location 425 based on a fingertip joint, and the surface 430 may then be calculated. According to some embodiments, the fingertip gap 440 may indicate a distance between the fingertip joint, or a finger pad location determined based on a location of the fingertip joint.

The flowchart 500 proceeds to block 510, where one or more velocity values are determined for different portions of the hand. In some embodiments, the velocity values may be based on tracking data for the joints over a series of frames. For example, a location of a particular joint in one frame may be compared against a location of the same joint in another frame in order to determine velocity. As shown at block 515, a fingertip velocity may be determined based on the velocity values and the fingertip joint location 425. In particular, a velocity of the fingertip joint location over a series of frames may be determined. In some embodiments, the velocity may be determined in a particular direction, such as in a direction toward the surface, or a change in fingertip gap distance 440. In addition, at block 520, a knuckle velocity may be determined. The knuckle velocity may be determine based on a motion of the knuckle joint location 420. The knuckle velocity may be determine based on the rate of change of the knuckle gap distance 435 over time.

According to one or more embodiments, one or more relative velocity values may be determined based on the fingertip velocity and the knuckle velocity, as shown at block 525. The relative velocity may be a difference between the knuckle velocity and the fingertip velocity. This difference may indicate whether the hand as a whole is moving faster or slower than the fingertip.

The process then proceeds to block 530, where a determination is made as to whether the relative velocity satisfies a velocity threshold. The velocity threshold is designed to distinguish between a deliberate touch and an accidental or unintended touch, and is used to determine which touch detection parameters to use, such as fingertip gap distance. The velocity threshold may be predetermined or dynamically determined based on various factors, such as the type of physical surface, the user preference, physical environmental factors, or an application context.

If a determination is made at block 530 that the relative velocity satisfies the velocity threshold, then the flowchart proceeds to block 540. For example, the relative velocity may satisfy the velocity threshold when the velocity of the fingertip is substantially greater than the velocity co the knuckle as the fingertip moves toward the surface. At block 540, a determination is made as to whether the fingertip gap distance satisfies a first distance threshold, such as when the fingertip gap distance is substantially small so as to determine the fingertip is sufficiently close to the surface. According to some embodiments, the first distance threshold may indicate a distance at which a touch event is likely to be detected. If the fingertip gap distance is not satisfied, then the flowchart concludes at block 550, and a make event is not detected. In some embodiments, the process define described in flowchart 500 may be repeated on a per frame basis, or as additional sensor data is captured and processed by an electronic device.

Returning to block 540, if a determination is made that the fingertip gap distance does satisfy the distance threshold, then the flowchart 500 proceeds to block 545. At block 545, a determination is made as to whether the fingertip gap distance is a local minimum value. The location of the fingertip that corresponds to the local minimum value gap distance is a point where the fingertip gap comes closest to the surface before increasing. When the local minimum value is identified, it may be determined that the finger has bounced off the physical surface without making a sustained contact.

Returning to block 530, if a determination is made that the relative velocity does not satisfy a velocity threshold, then the flowchart 500 proceeds to block 535. At block 535, a determination is made as to whether the fingertip motion and position satisfy a make event criteria. The make event criteria may be based on a fingertip velocity and/or knuckle velocity being above a threshold velocity and a fingertip gap distance satisfies being below a gap distance threshold. The gap distance threshold may be the same or may differ from the distance threshold of step 540. That is, if the relative velocity does not satisfy a velocity threshold, such as if the knuckle and fingertip are not moving at substantially different velocities, then a stricter distance threshold may be used. Alternatively, a larger distance may be used in combination with a velocity requirement. If the fingertip motion does not satisfy the make criteria, then the flowchart 500 concludes that block 560, and a make event is not detected.

Returning to block 535, if a determination is made that the fingertip motion and positioned satisfies the make criteria, then the flowchart 500 proceeds to block 545. As described above, at block 545, a determination is made as to whether the fingertip gap distance is a local minimum value. If the fingertip gap distance is not a local minimum value, then the flowchart concludes at block 550, and a make event is not detected.

Returning to block 545, if the fingertip gap distance is a local minimum value, then the flowchart proceeds to block 555. At block 555, a determination is made as to whether a correlated touch signal is detected. The touch signal may be received or determined from secondary sensor data, such as vibration data. For example, the touch signal may indicate that based on a vibration detected on the surface of the hand, a contact event has occurred between the hand and the surface. The touch signal may be used to confirm or reject the make event detected by the fingertip gap distance. Thus, if a correlated touch signal is detected, the flowchart concludes at block 565, and a make event is detected. By contrast, if a determination is made at block 555 that the correlated touch signal is not detected, then the flowchart concludes at block 560, and a make event is not detected. In some embodiments, the touch location can then be determined as the location on of the fingertip at the time the fingertip makes contact with the surface.

FIG. 6 shows, in flowchart form, an example technique for detecting a break event, according to one or more embodiments. A break event occurs when a user's finger or hand stops touching a physical surface after a make event. For purposes of explanation, the following steps will be described in the context of FIG. 4. However, it should be understood that the various actions may be taken by alternate components. In addition, the various actions may be performed in a different order. Further, some actions may be performed simultaneously, and some may not be required, or others may be added.

The flowchart 600 begins at block 565, where a make event is detected based on the criteria described in FIG. 5. A make event indicates that the user's finger or hand has been determined to make contact with the surface based on touch detection processes. For purposes of the technique described in flowchart 600, the makeup may have been detected in a prior frame, but a break event has not yet been detected.

At block 605, a fingertip gap distance is determined. The fingertip gap distance may be a distance between the fingertip location 425 and the surface 430, as shown in FIG. 4. In some embodiments, the fingertip gap distance 440 may be determined based on the distance between the fingertip joint of the hand 450 and the surface 430. Alternatively, the fingertip location 425 may be based on a fingertip joint. For example, a volume around the joint locations may be used to infer location information of a hand. The volume around the joint locations may be determined based on enrollment data for the user, predefined volumetric parameters, or the like. Thus, the fingertip joint may be an interior portion of the finger, whereas the fingertip location may be based on a finger pad position at the tip of the finger, or the like. The fingertip gap distance may be determined based on camera data, hand tracking data, or secondary sensor data, or a combination thereof.

The flowchart 600 proceeds to block 610, where velocity values for the hand are determined. In some embodiments, the velocity values may be based on tracking data for the joints over a series of frames. For example, a location of a particular joint in one frame may be compared against a location of the same joint in another frame in order to determine velocity. As shown at block 615, a fingertip velocity may be determined based on the velocity values and the fingertip joint location 425. In particular, a velocity of the fingertip joint location over a series of frames may be determined. In some embodiments, the velocity may be determined in a particular direction, such as in a direction toward the surface, or a change in fingertip gap distance 440. In addition, at block 620, a knuckle velocity may be determined. The knuckle velocity may be determine based on a motion of the knuckle joint location 420. The knuckle velocity may be determine based on the rate of change of the knuckle gap distance 435 over time.

At step 625, the process determines whether any of the fingertip velocity or the knuckle velocity falls below a break threshold. The break threshold may correspond to a velocity at which the finger moves away from the surface and may be used to determine one or more parameters by which a break event is detected, such as a fingertip gap distance. The break threshold may be a predefined value, or a dynamically determined value based on the surface characteristics, the user preferences, or other factors. If either of the fingertip velocity or the knuckle velocity falls below the break threshold, the flowchart 600 proceeds to block 630.

At step 630, a determination is made as to whether the fingertip gap distance satisfies a strict threshold. The strict threshold may be a predefined value, or a dynamically determined value based on the surface characteristics, the user preferences, or other factors. The strict threshold may be smaller than the gap distance threshold used for detecting a make event, as described above with respect to FIG. 5. If the fingertip gap distance satisfies the strict threshold, the flowchart 600 concludes at block 640 and a break event is detected. Returning to block 630, if the fingertip gap does not satisfy the strict threshold, then the flowchart 600 concludes at block 645 and a break event is not detected.

Returning to block 625, if a determination is made that no velocity value fell below a break threshold, then the flowchart 600 proceeds to block 635. At block 635, the process determines whether the fingertip gap distance satisfies a lax threshold. The lax threshold may be a predefined value, or a dynamically determined value based on the surface characteristics, the user preferences, or other factors.

The lax threshold may be larger than the strict threshold, but smaller than the gap distance threshold used for detecting a make event, as described with respect to FIG. 5. If the fingertip gap distance satisfies the lax threshold, the process concludes at block 640 and a break event is detected. By contrast, if the fingertip gap distance fails to satisfy the lax threshold, the flowchart 600 concludes at block 645, and a break event is not detected.

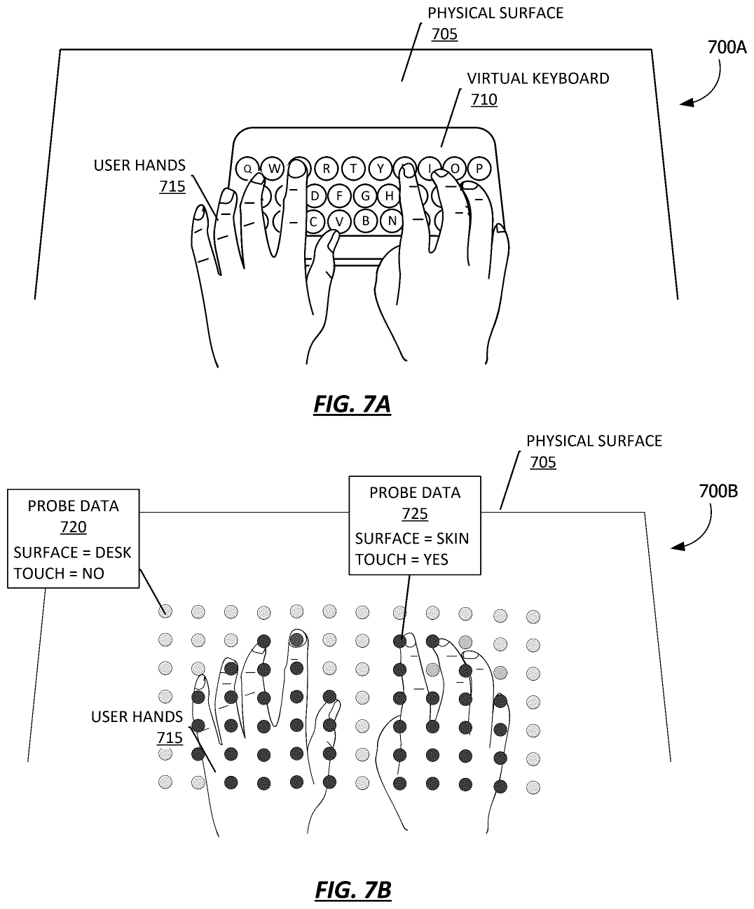

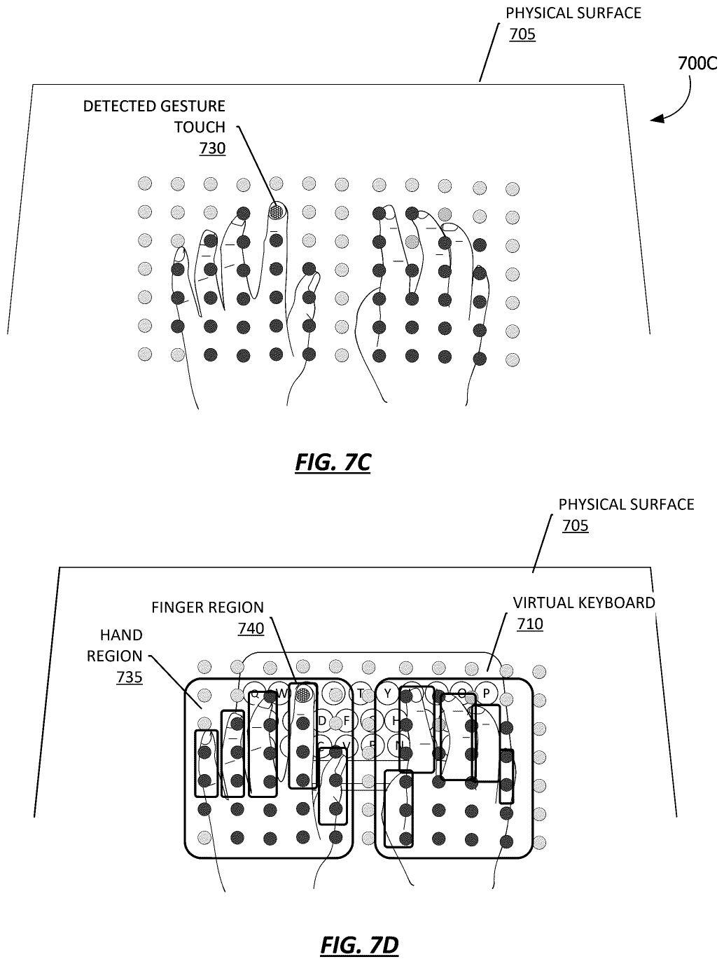

According to some embodiments, a dense surface touch sensor array may be used to track various characteristics of touch. FIGS. 7A-7D show example embodiments for using multiple probe locations to determine characteristics of touch, from which a gesture can be determined.

Turning to FIG. 7A, a mixed reality view 700A is presented, in which a virtual keyboard 710 is presented on a physical surface 705. The virtual keyboard can be projected on the virtual keyboard, or presented in image data such that it appears on top of the physical surface 705 for example using extended reality techniques. In the example embodiments, a user interacts with the virtual keyboard 710 by making contact with the physical surface 705 using the user hands 715. In some embodiments, the mixed reality view 700A may be from the perspective of the user, and/or an electronic device worn by the user, such as a head mounted device configured to provide mixed reality services.

Turning to FIG. 7B, a set of probe locations are shown over a view of the physical environment 700B. Specifically, the physical environment includes the physical surface 705 and the user hands 715. Touch sensors on electronic device probe a set of locations in front of the device. One example of a touch sensor suitable for use in a dense surface touch sensor array is a Frequency Modulated Continuous Wave (FMCW) sensor. FMCW sensors operate by transmitting a continuous laser or radio frequency signal whose frequency is modulated over time. When this signal reflects off a surface, the sensor receives the return signal and measures the frequency difference between the transmitted and received signals. This frequency difference corresponds to the distance between the sensor and the surface, enabling measurements of range or distance. Another potential touch sensor is a time-of-flight sensor.

The sensor data for each of these probed locations provides information such as surface category and a contact classification. For example, the surface category may indicate a material of the surface which was probed, or may differentiate between different materials being probed. For example, a reflective signal may be analyzed for signatures that may correlate to the surface upon which the signal was reflected. As an example, the surface category may distinguish between skin and hard surface such as a desk. In other examples, the classification may be more specific period for example, the fabric of sleeves for the material of jewelry can be detected. With respect to the touch classification, data may provide an indication as to whether a contact event is detected for any particular frame. For example, the sensor data may indicate a threshold distance between the hand and the surface, and/or change in velocity measurement that indicates a change in motion of the hand. In the example shown, probe data 720 refers to a probe location on the physical surface 705 for which the reflected signal indicates that the surface is part of the disk, and there's no touch is attached at this point. By contrast, probe data 725 refers to a probe location in which the surface is determined to be skin of the hand, and the hand is determined to be performing a touch with the physical surface 705.

According to some embodiments, temporal analysis can be applied to the sensor data to distinguish between points of contact which are associated with a user resting their hand, and points of contact which are part of an active gesture input. In some embodiments, an active gesture input may be detected based on changes in velocity over a series of frames which indicated touchdown, a touch up, a change of direction, or the like. In contrast, if a user is merely resting their hands, the velocity may be detected as zero or close to zero, with little or no change in direction.

FIG. 7C shows a physical environment view 700C with the overlaid probed location. As shown here, detected gesture touched 730 indicates a proper location at which a just your touch is identified based on temporal analysis. In some embodiments, this detected gesture touch can be used to activate a user input action. For example, in the case of the virtual keyboard 710, an input for the letter “E” may be activated. For example, the probe location for the detective gesture touch 730 can be compared against the presentation location of the virtual keyboard 710 to identify a portion of the virtual content which correlates to the gesture touch.

Turning to FIG. 7D, an example embodiment is presented in which more nuanced determinations can be made. In some embodiments, the diagram depicts a technique for identifying individual fingers performing a touch gesture. For example, based on the since your data for the probe locations, regions of the environment associated with the hand can be detected, such as hand region 735.

This may be performed by utilizing the combination of sensor data for a particular frame from different probed locations to that a region corresponding to a hand. In some embodiments, from there, subregions can be detected that correspond to different fingers, such as finger regions 740. Thus, the particular probed regions can be correlated to hand and finger locations, without the use of image data, or to enhance a correlation of touch and particular fingers using image data. In this example, because the detected gesture touch occurs as part of finger region 740, a particular user input action may be performed based on a combination of the location of the touch and/or the finger performing the touch.

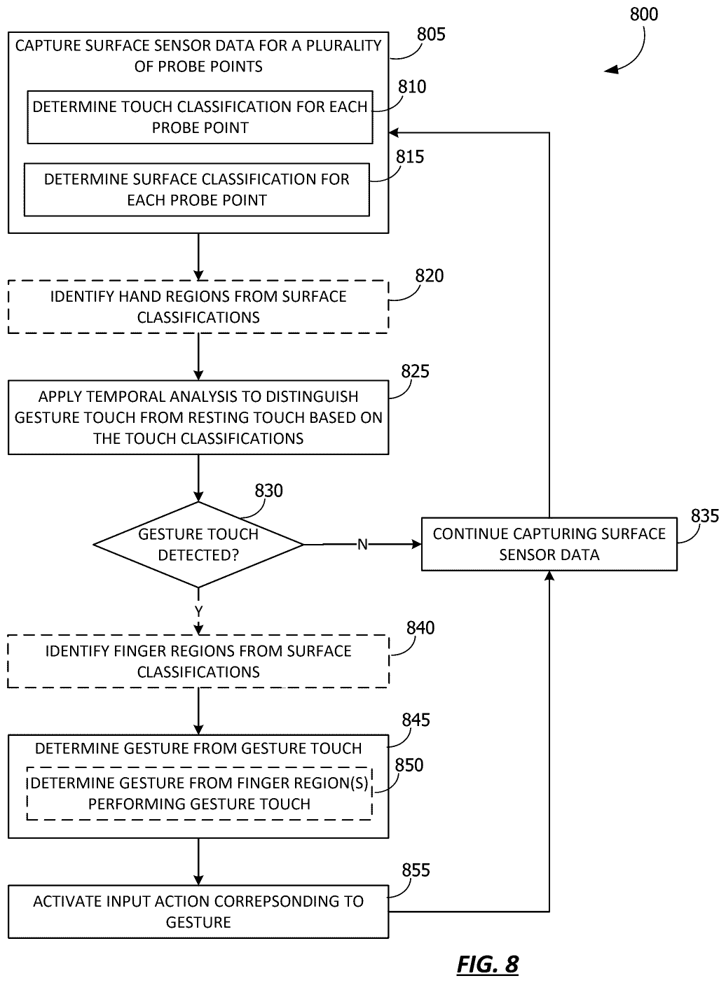

Turning to FIG. 8, a flowchart is presented illustrating an example technique for gating touch detection for multifinger gestures, in accordance with one or more embodiments. For purposes of explanation, the following 8 steps will be described in the context of particular devices and components. However, it should be understood that the various actions may be taken by alternate components. In addition, the various actions may be performed in a different order. Further, some actions may be performed simultaneously, and some may not be required, or others may be added.

The flowchart 800 begins at block 815, where surface sensor data is captured for each of the probe points. As shown above with respect to FIG. 7, the probe points may be an array of locations on surfaces in an environment which reflect sensor data from the surface sensors. As shown in block 810, the surface sensor data may include a touch classification for each probe point. The touch classification may indicate whether or not the touch is detected between a hand and surface at the particular probe point. In some embodiments, the touch classification may be determined based on an analysis of surrounding points. For example, the gap distance between the finger and the surface may be determined based on the reflected touch sensor data. In some embodiments, the surface may be detected in the environment from detected planes from one or more sets of sensor data. For example, scene understanding can be used to scan a physical environment for planes in the environment, and a detected surface maybe register in the environment. The surface locations can be analyzed in combination with depth information for the hand or finger as determined from the surface sensor data to determine a distance between the hand on the surface. As another example, a velocity may be determined for a particular point, which may indicate a touch down, touch up, or the like.

As shown in block 815, the surface sensor data may also include a surface classification for each probe point. The surface classification may be determined based on a signature extracted from the reflection signal. For example, the surface classification may be a classification of the signature, an identifier for the signature, or the like. According to some embodiments, the surface classification may differentiate between two or more different surface materials, such as skin, hard surface, clothing, or the like. Thus, each probe point may be assigned a surface classification.

The flowchart 800 proceeds to optional block 820, where hand regions are identified from the surface classifications. For example, the surface sensor data may be aggregated from the various probe points. Hand regions can be identified based on the sensor data. For example, regions associated with skin may be detected and determined to be hand regions. As another example, distance information can be used to detect the hands above the surface. A set of probe points indicative of a continuous region of skin may be detected as a hand. In some embodiments, the surface sensor data may be used in combination with image data to determine the hand regions. For example, a hand may be detected in the image data, and the hand region may be refined based on probed locations indicating skin is detected.

At block 825, a temporal analysis is applied to the surface sensor data to distinguish between points of contact that are caused by a user resting their hand, and points of contact that are caused by a user performing a gesture input. For purposes of this disclosure, the term gesture touch indicates an active interaction with the surface, for example for purposes of user input, whereas a resting touch refers to contact between a hand and a surface that is caused by a user resting their hand. The temporal analysis operation may involve monitoring changes in the surface sensor data from one or more probes over time to identify dynamic patterns that are characteristic of intentional user interactions. For instance, a rapid onset of contact followed by movement or pressure variation is indicative of a gesture touch, as opposed to the relatively static and sustained contact associated with a resting touch. To that end, a set of surface sensor data captured over a predefined time period may be analyzed to determine whether the data satisfies a resting criterion or a gesture touch criterion.

At block 830, determination is made as to whether a gesture touch is detected. If a gesture touches not detected in a particular frame, then the flowchart 800 proceeds to block 835, and the device continues to capture surface sensor data. In turn, the flowchart 800 then returns to block 805, and surface sensor data continues to be captured for the plurality of probe points.

Returning to block 830, if a gesture touch is detected, then the flowchart 800 proceeds to optional block 840. At optional block 840, finger regions are identified from the surface classifications. For example, if at block 820, hand regions are identified, then from the hand regions, finger regions for individual fingers can be identified based on a classification process, using predefined finger orientations on a hand, or the like. In some embodiments, a region of the aggregated surface sensor data can be determined to belong to individual fingers. As another example, individual probe points can be assigned to different fingers. Alternatively, the finger regions can be determined from image data which may be captured concurrently with the surface sensor data. For example, the image data may be correlated against the surface sensor data to determine which points correspond to different fingers of the hands.

The flowchart 800 proceeds to block 845, where a multifinger gesture is determined from the gesture touch. In some embodiments, a multifinger gesture can be determined based on the motion of the fingers performing the gesture touch period to that end, at optional block 850, the gesture may be determined based on the finger regions performing the gesture touch. As an example, a two finger tap using an index of middle finger may be distinguished from a two finger tap using an index and ring finger. As another example, a lateral pinch associated with the zooming in or zooming it out may be detected based on a concurrent gesture touch event performed by the thumb and the index finger moving towards or away from each other.

Accordingly, the characteristics of the detected gesture touch may be used to classify the gesture.

The flowchart 800 concludes at block 855, where an input action is activated corresponding to the gesture determined at block 845. In some embodiments, the input action that is activated may correspond to the classified gesture, as well as the fingers performing the gesture, motion detected in relation to the fingers, or the like. The flowchart 800 then returns to block 835, and the device continues to capture surface sensor data.

It should be understood that the various steps described above with respect to the flowcharts of FIGS. 2-3, 5-6, and 8 may be performed in an alternate order. Further, some of the various steps in the flowcharts may be combined in various combinations, according to one or more embodiments.

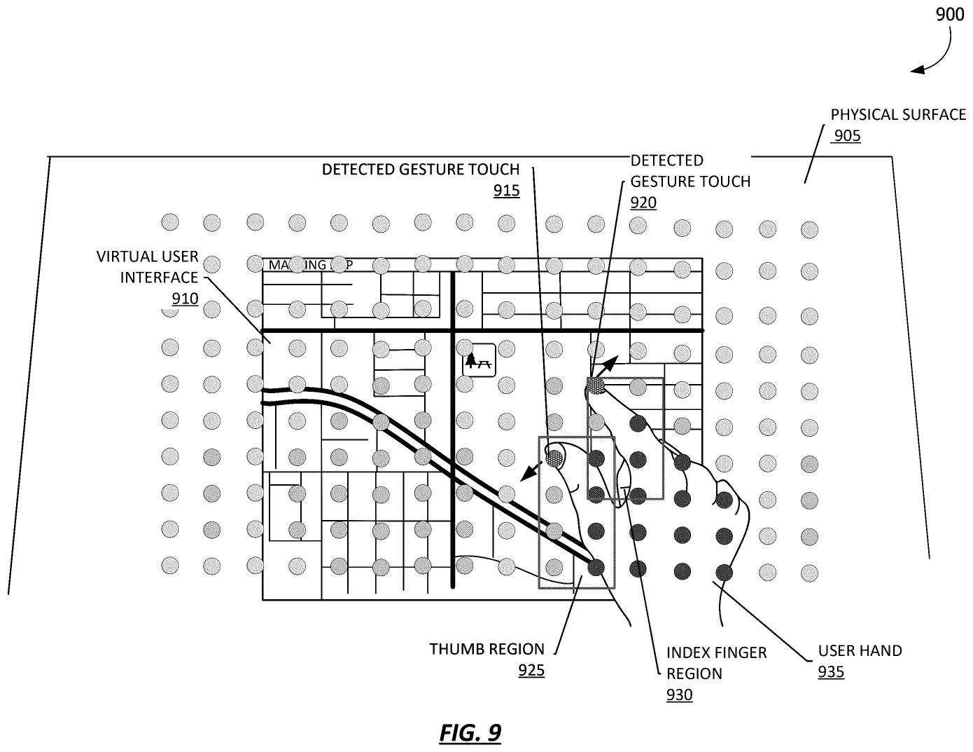

FIG. 9 presents an example multifinger input gesture in accordance with the embodiments described herein. A set of probe locations are shown over a view of the mixed reality environment 900. Specifically, the mixed reality environment includes the physical surface 905, the user hand 935, as well as a virtual user interface 910 showing a map. In some embodiments, the virtual user interface 910 may be projected on the surface 905, or may be visible on the surface from the augmented reality perspective of a user, such as through a see-through or pass-through display. Surface touch sensors on an electronic device probe a set of locations in front of the device. In the example shown, probe data at the thumb tip is determined to be associated with a detected gesture touch 915. Similarly, probe data at the thumb tip is determined to be associated with a detected gesture touch 920. As described above, the gesture touches may be detected based on a temporal analysis of the sensor data over a window of time. In this case, the temporal analysis may indicate that the points of contact satisfy a gesture touch criterion such that it is likely that the intent of the contact is to perform a gesture.

As described above, in some embodiments, the surface sensor data and/or image data may be used to determine regions associated with different fingers. In the example shown, thumb region 925 shows a region of sensor data which is determined to include the thumb, whereas index finger region 930 shows a region of sensor data which is determined to include the index finger. To that end, detected gesture touch 915 is determined to belong to the thumb region 925, whereas detected gesture touch 920 is determined to belong to the index finger region 930.

In some embodiments, the combination of the detected gesture touches, and/or the fingers determined to be performing the gesture touches, can be used to identify a gesture being performed. Further, the temporal analysis can be used to determine motion characteristics indicative of a gesture. For example, a gesture classifier may be used to determine a gesture being performed based on the points of contact for the detected gesture touches, and the fingers performing the gesture touches.

According to some embodiments, the gesture being performed may additionally, or alternatively, be dependent upon a user interface currently being presented. In this example, the thumb region 925 and the index finger region 930 are moving away from each other while making contact with the physical service 905. In this example, because the virtual user interface 910 includes a mapping interface, the input gesture may be determined to be a zoom out motion. To that end, a zoom out input action can be performed. In some embodiments, the user input action to be performed by determining a corresponding input location of the virtual user interface 910 being presented on the physical surface 905, with the location information for the detected gesture touch 915 and detected gesture touch 920. For example, a common coordinate system may be determined such that when the electronic device causes the mapping virtual user interface 910 to be zoomed in, the zoom is centered around a correct location, such as a region of the user interface centered between the index finger and thumb.

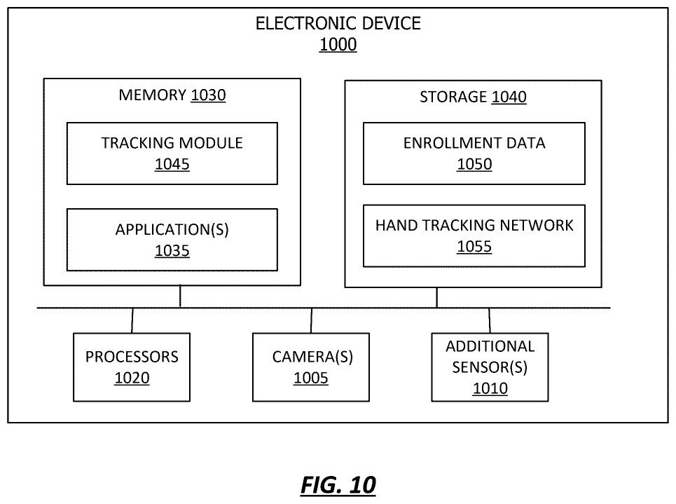

FIG. 10 shows, a simplified network diagram with components for detecting surface touch, according to one or more embodiments. Electronic device 100 may be part of a multifunctional device, such as a mobile phone, tablet computer, personal digital assistant, portable music/video player, wearable device, base station, laptop computer, desktop computer, network device, or any other electronic device. Electronic device 100 may be connected to each other and/or additional devices capable of providing similar or additional functionality across a network, a wired connection, a Bluetooth, or other short-range connection, among others.

Electronic device 1000 may include processor, such as a central processing unit (CPU) 1020. Processor 1020 may each be a system-on-chip such as those found in mobile devices and include one or more dedicated graphics processing units (GPUs). Further, processor 1020 may include multiple processors of the same or different type. Electronic Device 1000 may also include a memory 1030. Memory 1030 may include one or more different types of memory, which may be used for performing device functions in conjunction with processor 1020. For example, memory 1030 may include cache, ROM, RAM, or any kind of transitory or non-transitory computer readable storage medium capable of storing computer readable code. Memory 1030 may store various programming modules, for example for execution by processor 1020, including touch tracking module 1045 and/or other applications 1035. Electronic device 1000 may also include storage 1040. Storage 1040 may include one more non-transitory computer-readable storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). According to one or more embodiments, the storage 1040 may store data to be used in conjunction with the executable modules shown in memory 1030. For example, storage 1040 may include enrollment data 1050 which may be used for hand tracking. As another example, hand tracking network 1055 maybe a pre-trained network configured to ingest sensor data such as image data and/or depth data, and predict characteristics of a hand in the image, such as joint location, hand pose, and the like.

In one or more embodiments, electronic device 1000 may include other components utilized for touch detection, such as one or more cameras or camera systems (i.e., more than one camera) 1005 and/or other sensors 1010, such as a depth sensor, vibration sensor, or the like. In one or more embodiments, each of the one or more cameras 1005 may be a traditional RGB camera, or a depth camera. Further, the one or more cameras 1005 may include a stereo-or other multi-camera system, a time-of-flight camera system, or the like which capture images from which depth information of a scene may be determined.

In one or more embodiments, the tracking module 1045 may determine whether to run a touch detection process to estimate whether a touch even has occurred or is occurring. The tracking module 1045 may use the sensor data from camera(s)1020 and/or additional sensor(s) 1010 to determine a proximity of the hand to the surface, and my initiate touch detection based on the proximity.

Although electronic device 1000 is depicted as comprising the numerous components described above, in one or more embodiments, the various components may be distributed across multiple devices. Particularly, in one or more embodiments, the tracking module 1045 may be distributed differently or may be present elsewhere in additional systems which may be communicably coupled to the electronic device 1000. Thus, the electronic device 1000 may not be needed to perform one or more techniques described herein, according to one or more embodiments. Accordingly, although certain calls and transmissions are described herein with respect to the particular systems as depicted, in one or more embodiments, the various calls and transmissions may be made differently directed based on the differently distributed functionality. Further, additional components may be used, some combination of the functionality of any of the components may be combined.

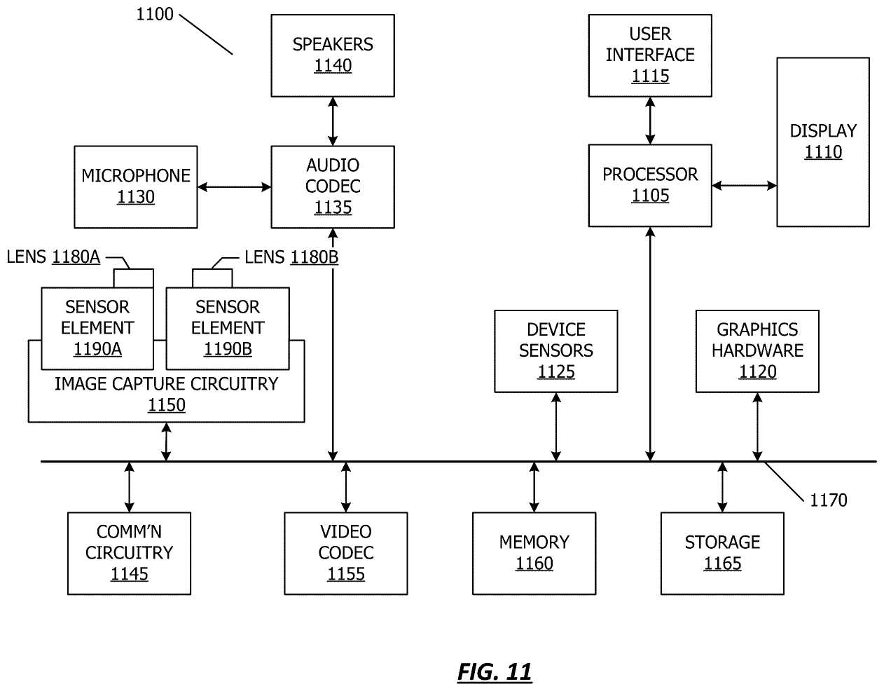

Referring now to FIG. 11, a simplified functional block diagram of illustrative multifunction electronic device 1100 is shown according to one embodiment. Electronic device 1100 may be a multifunctional electronic device, or may have some or all of the described components of a multifunctional electronic device described herein. Multifunction electronic device 1100 may include processor 1105, display 1110, user interface 1115, graphics hardware 1120, device sensors 1125 (e.g., proximity sensor/ambient light sensor, accelerometer and/or gyroscope), microphone 1130, audio codec(s) 1135, speaker(s) 1140, communications circuitry 1145, digital image capture circuitry 1150 (e.g., including camera system) video codec(s) 1155 (e.g., in support of digital image capture unit), memory 1160, storage device 1165, and communications bus 1170. Multifunction electronic device 1100 may be, for example, a digital camera or a personal electronic device such as a personal digital assistant (PDA), personal music player, mobile telephone, or a tablet computer.

Processor 1105 may execute instructions necessary to carry out or control the operation of many functions performed by device 1100 (e.g., such as the generation and/or processing of images as disclosed herein). Processor 1105 may, for instance, drive display 1110 and receive user input from user interface 1115. User interface 1115 may allow a user to interact with device 1100. For example, user interface 1115 can take a variety of forms, such as a button, keypad, dial, a click wheel, keyboard, display screen and/or a touch screen. Processor 1105 may also, for example, be a system-on-chip such as those found in mobile devices and include a dedicated graphics processing unit (GPU). Processor 1105 may be based on reduced instruction-set computer (RISC) or complex instruction-set computer (CISC) architectures or any other suitable architecture and may include one or more processing cores. Graphics hardware 1120 may be special purpose computational hardware for processing graphics and/or assisting processor 1105 to process graphics information. In one embodiment, graphics hardware 1120 may include a programmable GPU.

Image capture circuitry 1150 may include two (or more) lens assemblies 1180A and 1180B, where each lens assembly may have a separate focal length. For example, lens assembly 1180A may have a short focal length relative to the focal length of lens assembly 1180B. Each lens assembly may have a separate associated sensor element 1190. Alternatively, two or more lens assemblies may share a common sensor element. Image capture circuitry 1150 may capture still and/or video images. Output from image capture circuitry 1150 may be processed, at least in part, by video codec(s) 1155 and/or processor 1105 and/or graphics hardware 1120, and/or a dedicated image processing unit or pipeline incorporated within circuitry 1165. Images so captured may be stored in memory 1160 and/or storage 1165.

Sensor and camera circuitry 1150 may capture still and video images that may be processed in accordance with this disclosure, at least in part, by video codec(s) 1155 and/or processor 1105 and/or graphics hardware 1120, and/or a dedicated image processing unit incorporated within circuitry 1150. Images so captured may be stored in memory 1160 and/or storage 1165. Memory 1160 may include one or more different types of media used by processor 1105 and graphics hardware 1120 to perform device functions. For example, memory 1160 may include memory cache, read-only memory (ROM), and/or random-access memory (RAM). Storage 1165 may store media (e.g., audio, image, and video files), computer program instructions or software, preference information, device profile information, and any other suitable data. Storage 1165 may include one more non-transitory computer-readable storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 1160 and storage 1165 may be used to tangibly retain computer program instructions or code organized into one or more modules and written in any desired computer programming language. When executed by, for example, processor 1105 such computer program code may implement one or more of the methods described herein.

The scope of the disclosed subject matter should be determined with reference to the appended claims, along with the full scope of equivalents to which such claims are entitled. In the appended claims, the terms “including” and “in which” are used as the plain-English equivalents of the respective terms “comprising” and “wherein.”

1. A method comprising:
determining, based on first sensor data of a first type, a hand location of a hand;
in response to determining that the hand location satisfies a proximity threshold to a physical surface:
initiating a monitoring process of a surface of the hand, wherein the monitoring process comprises capturing second sensor data of a second type different than the first sensor data,
determining a touch status based on second sensor data, and
triggering a user input action based on the touch status.

2. The method of claim 1, wherein the first sensor data comprises camera data.

3. The method of claim 1, further comprising:
determining, from the second sensor data, a surface type and a contact state.

4. The method of claim 1, wherein determining the hand location comprises:
obtaining one or more joint locations for the hand based on hand tracking data;
generating a hand geometry based on the one or more joint locations; and
determining the hand location based on a depth value for the hand geometry.

5. The method of claim 1, wherein the monitoring process comprises:
obtaining, by a camera, image data of the hand;
identifying a target location on a back surface of the hand; and
probing and collect the second sensor data from the target location from a non-camera sensor.

6. The method of claim 1, wherein the monitoring process comprises:
obtaining, by a camera, image data of the hand;
identifying a first target location on a first finger of the hand;
identifying a second target location on a second finger of the hand; and
probing and collect the second sensor data from the first target location and the second target location.

7. The method of claim 6, further comprising:
detecting a multifinger gesture based on the second sensor data; and
activating a user input action based on the multifinger gesture.

8. A non-transitory computer readable medium comprising computer readable code executable by the one or more processors to:
determine, based on first sensor data of a first type, a hand location of a hand;
in response to determining that the hand location satisfies a proximity threshold to a physical surface:
initiate a monitoring process of a surface of the hand, wherein the monitoring process comprises capturing second sensor data of a second type different than the first sensor data,
determine a touch status based on second sensor data, and
trigger a user input action based on the touch status.

9. The non-transitory computer readable medium of claim 8, wherein the first sensor data comprises camera data.

10. The non-transitory computer readable medium of claim 8, further comprising computer readable code to
determine, from the second sensor data, a surface type and a contact state.

11. The non-transitory computer readable medium of claim 8, wherein the computer readable code to determine the hand location comprises computer readable code to:
obtain one or more joint locations for the hand based on hand tracking data;
generate a hand geometry based on the one or more joint locations; and
determine the hand location based on a depth value for the hand geometry.

12. The non-transitory computer readable medium of claim 8, wherein the monitoring process comprises computer readable code to:
obtain, by a camera, image data of the hand;
identify a target location on a back surface of the hand; and
probe and collect the second sensor data from the target location from a non-camera sensor.

13. The non-transitory computer readable medium of claim 8, wherein the monitoring process comprises computer readable code to:
obtain, by a camera, image data of the hand;
identify a first target location on a first finger of the hand;
identify a second target location on a second finger of the hand; and
probe and collect the second sensor data from the first target location and the second target location.

14. The non-transitory computer readable medium of claim 13, further comprising computer readable code to:
detect a multifinger gesture based on the second sensor data; and
activate a user input action based on the multifinger gesture.

15. A system comprising:
one or more processors; and
one or more computer readable media comprising computer readable code executable by the one or more processors to:
determine, based on first sensor data of a first type, a hand location of a hand;
in response to determining that the hand location satisfies a proximity threshold to a physical surface:
initiate a monitoring process of a surface of the hand, wherein the monitoring process comprises capturing second sensor data of a second type different than the first sensor data, determine a touch status based on second sensor data, and trigger a user input action based on the touch status.

16. The system of claim 15, further comprising computer readable code to
determine, from the second sensor data, a surface type and a contact state.

17. The system of claim 15, wherein the computer readable code to determine the hand location comprises computer readable code to:
obtain one or more joint locations for the hand based on hand tracking data;
generate a hand geometry based on the one or more joint locations; and
determine the hand location based on a depth value for the hand geometry.

18. The system of claim 15, wherein the monitoring process comprises computer readable code to:
obtain, by a camera, image data of the hand;
identify a target location on a back surface of the hand; and
probe and collect the second sensor data from the target location from a non-camera sensor.

19. The system of claim 15, wherein the monitoring process comprises computer readable code to:
obtain, by a camera, image data of the hand;
identify a first target location on a first finger of the hand;
identify a second target location on a second finger of the hand; and
probe and collect the second sensor data from the first target location and the second target location.

20. The system of claim 19, further comprising computer readable code to:
detect a multifinger gesture based on the second sensor data; and
activate a user input action based on the multifinger gesture.
